(19) United States
(12) Patent Application Publication
(10) Pub. No.: US 2018/0152073 A1
(43) Pub. Date: May 31, 2018

(54) STATOR UNIT AND MOTOR

(71) Applicant: Nidec Corporation, Kyoto (JP)

(72) Inventors: Megumi MICHISHITA, Kyoto (JP); Hideki AOI, Kyoto (JP); Takaya OKUNO, Kyoto (JP); Sakae NOGAMI, Kyoto (JP)

(21) Appl. No.: 15/825,246

(22) Filed: Nov. 29, 2017

(30) Foreign Application Priority Data
Nov. 30, 2016 (JP) 2016-232906

(51) Int. Cl. H02K 5/10; H02K 5/16; H02K 1/04; H02K 5/02

(52) U.S. Cl. CPC H02K 5/10; H02K 5/02; H02K 1/04; H02K 5/16

(57) ABSTRACT

A stator unit for use in a motor includes a cylindrical bearing housing, a stator core, a resin insulator, a conductive wire, a circuit board, a molded resin portion, and an elastic member. The stator core is fixed to an outer circumferential surface of the bearing housing. The insulator is attached to the stator core. At least one of the bearing housing and the insulator has a ring-shaped groove. The conductive wire is wound around the teeth with the insulator therebetween. The circuit board is electrically coupled to the conductive wire. The molded resin portion covers the stator core, the insulator, the conductive wire, and the circuit board. The elastic member is fitted in the groove and interposed between the bearing housing and the insulator.

### CROSS REFERENCE TO RELATED APPLICATIONS

This application claims the benefit of priority to Japanese Patent Application No. 2016-232906 filed on Nov. 30, 2016. The entire contents of this application are hereby incorporated herein by reference.

### BACKGROUND OF THE INVENTION

### 1. Field of the Invention

The present disclosure relates to a stator unit and a motor.

### 2. Description of the Related Art

A what-is-called mold motor including a molded resin portion that covers a stator is known in the art. The mold motor is excellent in waterproof property, and vibration-proof property and soundproof property during driving. In particular, the mold motor is prevented from intrusion of water droplets into a current-carrying portion, such as coils in the stator, by the molded resin portion. A known mold motor is disclosed in, for example, Japanese Unexamined Patent Application Publication No. 04-58062.

The motor disclosed in Japanese Unexamined Patent Application Publication No. 04-58062 is a so-called inner rotor type motor in which a rotor magnet is disposed inside the stator. In contrast, a so-called outer rotor type motor in which a rotor magnet is disposed outside the stator is known as a motor for use in an axial fan or the like. To enhance the waterproof property, some recent outer rotor type motors adopt a structure in which the stator is covered with a molded resin portion. However, motors for use in communication base stations which are highly likely to be exposed to outside air or home electric appliances such as refrigerators are required to have a higher waterproof property.

### SUMMARY OF THE INVENTION

An exemplary embodiment of the present disclosure is a stator unit for use in a motor. The stator unit includes a cylindrical bearing housing disposed along a central axis extending in a vertical direction, a stator core fixed to an outer circumferential surface of the bearing housing and comprising a plurality of teeth protruding radially outward, a resin insulator attached to the stator core, a conductive wire wound around the teeth with the insulator therebetween, a circuit board electrically coupled to the conductive wire, a molded resin portion covering the stator core, the insulator, the conductive wire, and the circuit board. At least one of the bearing housing and the insulator has a ring-shaped groove. The stator unit further includes an elastic member fitted in the groove and interposed between the bearing housing and the insulator.

The above and other elements, features, steps, characteristics and advantages of the present discloser will become more apparent from the following detailed description of the preferred embodiments with reference to the attached drawings.

### BRIEF DESCRIPTION OF THE DRAWINGS

FIG. 1 is a longitudinal sectional view of a motor according to an embodiment of the present disclosure.

FIG. 2 is a partial longitudinal sectional view of the motor according to an embodiment of the present disclosure.

FIG. 3 is a partial longitudinal sectional view of a motor according to a modification.

FIG. 4 is a partial longitudinal sectional view of a motor according to another modification.

FIG. 5 is a partial longitudinal sectional view of a motor according to still another modification.

### DETAILED DESCRIPTION OF THE PREFERRED EMBODIMENTS

An exemplary embodiment of the present disclosure will be described hereinbelow with reference to the drawings. In the present disclosure, a direction parallel to the central axis of a motor including a stator unit is referred to as “axial direction”, a direction perpendicular to the central axis of the motor is referred to as “radial direction”, and a direction along an arc centered on the central axis of the motor is referred to as “circumferential direction”. In the present disclosure, the shapes of the components and the positional relationship among them will be described, with the axial direction as the vertical direction and the circuit board being lower than the stator. However, the definition on the vertical direction is not intended to limit the orientation of the motor according to an embodiment of the present disclosure at the time of manufacturing and in operation.

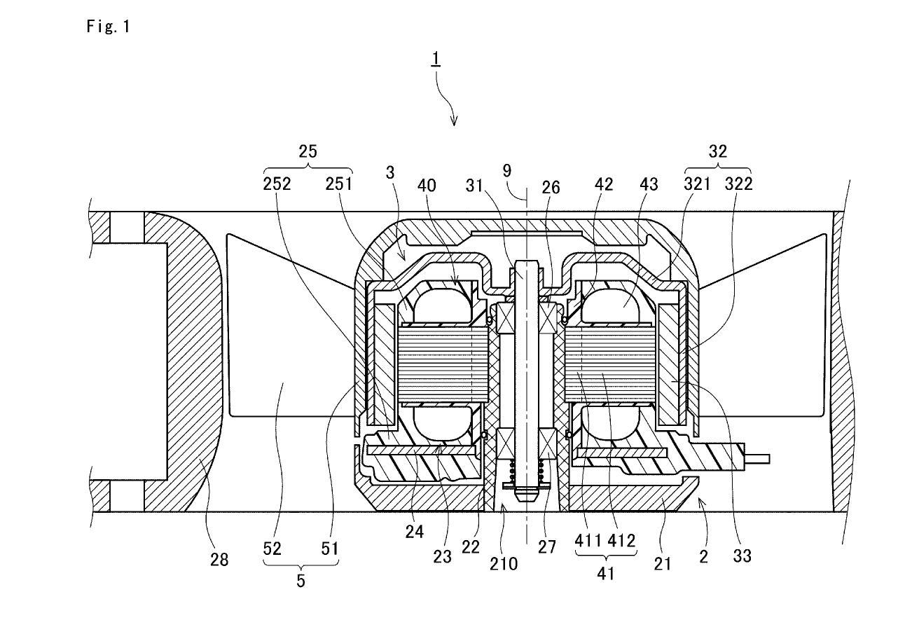

FIG. 1 is a longitudinal sectional view of a motor 1 including a stator unit 2 according to an embodiment of the present disclosure. The motor 1 is used as a driving source for a fan that supplies a cooing air flow, for example, in a communication base station in which a plurality of electronic devices are disposed. In some embodiments, the stator unit and the motor of the present disclosure may also be used for other uses such as home electric appliances or in-vehicle parts.

As illustrated in FIG. 1, the motor 1 includes a stator unit 2 and a rotor unit 3. The stator unit 2 is fixed to the frame of an apparatus in which the motor 1 is mounted. The rotor unit 3 is supported so as to be rotatable with respect to the stator unit 2 via an upper bearing portion 26 and a lower bearing portion 27.

The stator unit 2 includes a base 21, a bearing housing 22, a stator 23, a circuit board 24, and a molded resin portion 25.

The base 21 expands below the stator 23 in a direction substantially perpendicular to a central axis 9. In the present embodiment, the base 21 and a cylindrical outer wall 28 forming the wind tunnel of the fan are formed of a single resin. The outer circumferential portion of the base 21 and the lower end of the outer wall 28 are connected together with a plurality of ribs (not shown). The base 21 and the outer wall 28 may be different members. The base 21 has a central hole 210. The central hole 210 passes through the base 21 along the central axis 9.

The bearing housing 22 is a cylindrical member disposed along the central axis 9. The bearing housing 22 is positioned radially inside the stator 23 and the circuit board 24 and radially outside the upper bearing portion 26 and the lower bearing portion 27. An example of the material of the bearing housing 22 is metal such as brass or iron. This allows the upper bearing portion 26 and the lower bearing portion 27 to be disposed with high accuracy. However, the material of the bearing housing 22 may be resin.

The lower end of the bearing housing 22 is inserted in the central hole 210 of the base 21. The lower end of the bearing housing 22 and the inner circumferential portion of the base 21 are fixed together with an adhesive or by press fitting. The resin base 21 may be integrated with the metal bearing housing 22 by injection molding. Alternatively, the bearing housing 22 and the base 21 may be molded into a single resin member. In this case, the number of parts is smaller than a case where the bearing housing 22 and the base 21 are different members, improving the production efficiency of the motor 1.

The stator 23 is an armature that generates a rotating magnetic field according to the driving current. The stator 23 includes a stator core 41, an insulator 42, and a plurality of coils 43. The stator core 41 is made of a laminated steel plate which is a magnetic material. The stator core 41 includes a ring-shaped core back 411 and a plurality of teeth 412. The inner circumferential surface of the core back 411 is fixed to the outer circumferential surface of the bearing housing 22. The teeth 412 protrude radially outward from the core back 411. The insulator 42 is attached to the stator core 41. The upper surface, the lower surface, and both circumferential surfaces of the teeth 412 are covered by the insulator 42. The insulator 42 is made of resin which is an insulating material. The coils 43 are conductive wires wound around the teeth 412, with the insulator 42 therebetween. The insulator 42 is interposed between the stator core 41 and the coils 43 to prevent the stator core 41 and the coils 43 from being electrically short-circuited.

The circuit board 24 is positioned below the stator 23 and above the base 21. The circuit board 24 expands in a ring shape and in a direction perpendicular to the central axis 9 around the bearing housing 22. An electric circuit is mounted on at least the upper surface and the lower surface of the circuit board 24.

The ends of the conductive wires constituting the coils are electrically connected to the electric circuit of the circuit board 24 via terminal pins (not shown). When power is supplied from an external power source to the circuit board 24, a driving current is supplied from the electric circuit of the circuit board 24 to the plurality of coils 43.

The molded resin portion 25 covers the stator core 41, the insulator 42, and the circuit board 24. An example of the material of the molded resin portion 25 is a thermosetting unsaturated polyester resin. The molded resin portion 25 is obtained by pouring resin into the cavity of a mold in which the stator 23 and the circuit board 24 are housed and hardening the resin. In other words, the molded resin portion 25 is a molded resin product in which the stator 23 and the circuit board 24 are integrated by injection molding.

Covering the stator 23 and the circuit board 24 by the molded resin portion 25 in this manner prevents water droplets from attaching to the stator 23 and the circuit board 24. This therefore reduces or eliminates failure of the current-carrying parts in the motor 1 due to attachment of water droplets. Part of the surface of the stator 23 may be exposed from the molded resin portion 25. In the present embodiment, the radially outer end face of the teeth 412 and the inner circumferential surface of the insulator 42 are exposed from the molded resin portion 25. However, the radially outer end face of the teeth 412 and the inner circumferential surface of the insulator 42 are covered by an insulating coating. Therefore, even if the radially outer end face of the teeth 412 and the inner circumferential surface of the insulator 42 are exposed from the molded resin portion 25, failure due to attachment of water droplets can be reduced or eliminated.

The upper bearing portion 26 and the lower bearing portion 27 are mechanisms for rotatably supporting a shaft 31 (descried later). The upper bearing portion 26 is interposed between the upper end of the bearing housing 22 and the shaft 31. The lower bearing portion 27 is interposed between the bearing housing 22 and the shaft 31 below the upper bearing portion 26. An example of the upper bearing portion 26 and the lower bearing portion 27 is a ball bearing that rotates an inner ring and an outer ring relative to each other via balls. The outer ring of the upper bearing portion 26 and the outer ring of the lower bearing portion 27 are fixed to the inner circumferential surface of the bearing housing 22. The inner ring of the upper bearing portion 26 and the inner ring of the lower bearing portion 27 are fixed to the outer circumferential surface of the shaft 31. Thus, the shaft 31 is supported so as to be rotatable about the central axis 9 with respect to the bearing housing 22.

Instead of the ball bearing, another type of bearing may be used for the upper bearing portion 26 and the lower bearing portion 27.

The rotor unit 3 includes the shaft 31, a rotor holder 32, and a plurality of magnets 33.

The shaft 31 is a columnar member extending along the central axis 9. An example of the material of the shaft 31 is metal such as stainless steel. Part of the shaft 31 including the lower end is housed radially inside the bearing housing 22. The upper end of the shaft 31 projects upward from the bearing housing 22 and the stator 23. The shaft 31 is rotatably supported by the upper bearing portion 26 and the lower bearing portion 27.

The rotor holder 32 is a member that rotates with the shaft 31. An example of the material of the rotor holder 32 is metal such as iron which is a magnetic material. The rotor holder 32 includes a holder top plate 321 and a holder cylindrical portion 322. The holder top plate 321 expands in a direction substantially perpendicular to the central axis 9. The center of the holder top plate 321 is fixed to the shaft 31. The holder cylindrical portion 322 extends axially downward in a cylindrical shape from the outer circumferential portion of the holder top plate 321.

The plurality of magnets 33 are fixed to the inner circumferential surface of the holder cylindrical portion 322. The radially inner surface of each magnet 33 is an N-pole or S-pole face. The plurality of magnets 33 are arrayed in a circumferential direction in such a manner that an N-pole face and an S-pole face are alternately arranged. The radially outer end faces of the teeth 412 and the radially inner surface of the magnets 33 face each other in the radial direction.

When the motor 1 is driven, a driving current is supplied from the circuit board 24 to the coils 43 via terminal pins. This causes a rotating magnetic field to be generated at the plurality of teeth 412 of the stator core 41. This causes a circumferential torque to be generated between the teeth 412 and the magnets 33. Consequently, the rotor unit 3 rotates about the central axis 9.

The motor 1 of the present embodiment includes an impeller 5. The impeller 5 includes an impeller cup 51 and a plurality of blades 52. The impeller cup 51 is fixed to the rotor holder 32. The plurality of blades 52 expand radially outward from the outer circumferential surface of the impeller cup 51. When the motor 1 is driven, the impeller 5 rotates together with the rotor unit 3. This causes an air flow from above to below to be generated inside the outer wall 28.

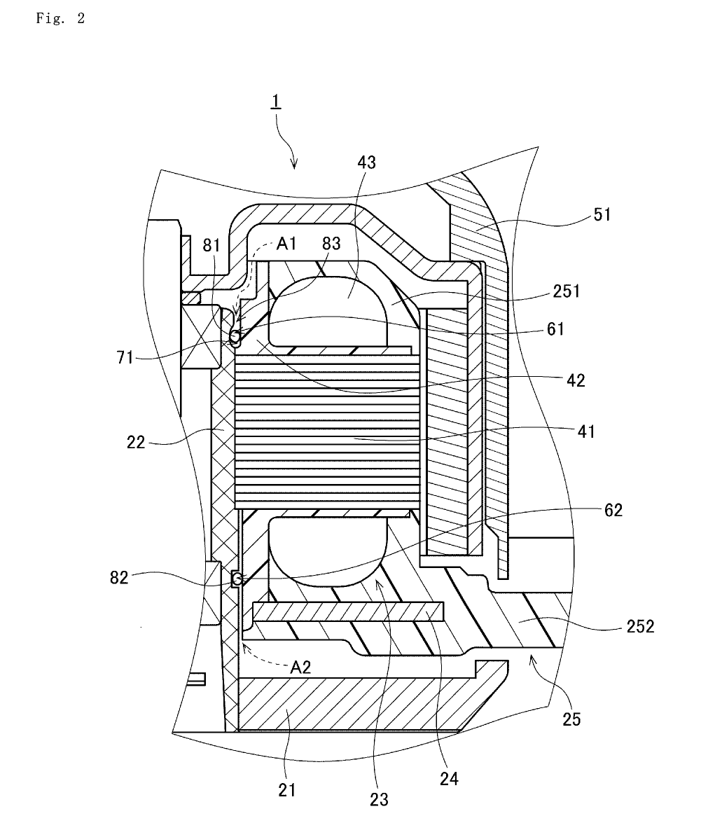

FIG. 2 is a partial longitudinal sectional view of the motor 1. The motor 1 installed outdoors, such as communication base stations, are particularly required to have a high waterproof property. For that purpose, the motor 1 of the present embodiment has a configuration in which the stator 23 and the circuit board 24 are covered by the molded resin portion 25, as described above. However, water droplets attaching to the motor 1 may intrude into the boundary between the insulator 42 and the bearing housing 22, which is not covered by the molded resin portion 25, as indicated by broken-line arrows A1 and A2 in FIG. 2. If water droplets intrudes into the boundary between the insulator 42 and the bearing housing 22, the water droplets may reach the coils 43 or the circuit board 24 along the surfaces of the insulator 42 and the stator core 41.

Hereinafter, a structure for preventing such intrusion of water droplets will be described.

As illustrated in FIG. 2, the outer circumferential surface of the bearing housing 22 has a ring-shaped first inner groove 61. The inner circumferential surface of the insulator 42 has a ring-shaped first outer groove 71. The first inner groove 61 and the first outer groove 71 are positioned axially above the stator core 41. The first inner groove 61 is recessed radially inward from the outer circumferential surface of the bearing housing 22. The first outer groove 71 is recessed radially outward from the inner circumferential surface of the insulator 42.

The first inner groove 61 and the first outer groove 71 are opposed in the radial direction. A ring-shaped first O-ring 81 is interposed in the gap in the radial direction between the first inner groove 61 and the first outer groove 71. The first O-ring 81 is a ring-shaped resin member (a first elastic member) which is more likely to be elastically deformed than the insulator 42. An example of the material of the first O-ring 81 is elastomer. The first O-ring 81 is compressed more than in the natural state by being sandwiched between the bearing housing 22 and the insulator 42. Consequently, the first O-ring 81 is in close-contact with both the bearing housing 22 and the insulator 42.

Providing the first O-ring 81 prevents water droplets from intruding into the molded resin portion 25 from above the stator unit 2 between the bearing housing 22 and the insulator 42. This further prevents water droplets from attaching to the coils 43 and the circuit board 24, which are current-carrying parts in the molded resin portion 25.

In particular, the first O-ring 81 of the present embodiment is fitted between the first inner groove 61 and the first outer groove 71. This prevents axial displacement of the first O-ring 81. However, either one of the first inner groove 61 or the first outer groove 71 may be omitted. In other words, it is only required that the first O-ring 81 is fitted in a ring-shaped groove provided on at least one of the bearing housing 22 and the insulator 42.

However, providing a groove for holding the first O-ring 81 in each of the bearing housing 22 and the insulator 42, as in the present embodiment, makes it easy to provide a space for disposing the first O-ring 81. This prevents a decrease in the strength of the bearing housing 22 and the insulator 42 due to the grooves.

The first inner groove 61 and the first outer groove 71 communicate with a space outside the stator unit 2 through a gap 83 between the bearing housing 22 and the insulator 42. At the time of manufacturing the stator unit 2, the stator 23 including the insulator 42 is fixed to the bearing housing 22, and thereafter, the first O-ring 81 is inserted between the first inner groove 61 and the first outer groove 71 through the gap 83. This allows the first O-ring 81 to be easily attached.

In the present embodiment, the bearing housing 22, which is one of the pair of members that hold the first O-ring 81, is made of metal. The metal bearing housing 22 is less prone to be deformed even under a pressure from the first O-ring 81 than a resin member. For that reason, the first O-ring 81 comes into closer-contact with the bearing housing 22 and the insulator 42 than a case where the pair of members that hold the first O-ring 81 are both made of resin. This further prevents water droplets from intruding into the molded resin portion 25.

As illustrated in FIG. 2, a ring-shaped second inner groove 62 is provided on the outer circumferential surface of the bearing housing 22. The second inner groove 62 is positioned axially below the stator core 41. The second inner groove 62 is recessed radially inward from the outer circumferential surface of the bearing housing 22.

A ring-shaped second O-ring 82 is interposed in the gap in the radial direction between the second inner groove 62 and the insulator 42. The second O-ring 82 is a ring-shaped resin member (a second elastic member) which is more likely to be elastically deformed than the insulator 42. An example of the material of the second O-ring 82 is elastomer. The second O-ring 82 is compressed more than in the natural state by being sandwiched between the bearing housing 22 and the insulator 42. Consequently, the second O-ring 82 is in close-contact with both the bearing housing 22 and the insulator 42.

Providing the second O-ring 82 prevents water droplets from intruding into the molded resin portion 25 from below the stator unit 2 between the bearing housing 22 and the insulator 42. This further prevents water droplets from attaching to the coils 43 and the circuit board 24, which are current-carrying parts in the molded resin portion 25.

In particular, the second O-ring 82 of the present embodiment is fitted in the second inner groove 62. This prevents axial displacement of the second O-ring 82. However, a second outer groove may be further provided at a position on the inner circumferential surface of the insulator 42 facing the second inner groove 62. Instead of the second inner groove 62, a second outer groove may be provided. In other words, it is only required that the second O-ring 82 is fitted in a ring-shaped groove provided on at least one of the bearing housing 22 and the insulator 42.

In the present embodiment, the bearing housing 22, which is one of the pair of members that hold the second O-ring 82, is made of metal. The metal bearing housing 22 is less prone to be deformed even under a pressure from the second O-ring 82 than a resin member. For that reason, the second O-ring 82 comes into closer-contact with the bearing housing 22 and the insulator 42 than a case where the pair of members that hold the second O-ring 82 are both made of resin. This further prevents water droplets from intruding into the molded resin portion 25.

In the present embodiment, the second O-ring 82 is disposed axially above the circuit board 24. In other words, the axial position of the circuit board 24 and the axial position of the second O-ring 82 differ. Thus, disposing the second O-ring 82 at a position axially away from the circuit board 24 prevents the pressure of the second O-ring 82 from being applied to the circuit board 24.

The molded resin portion 25 of the present embodiment includes a small-diameter portion 251 and a large-diameter portion 252. The large-diameter portion 252 is positioned axially below the small-diameter portion 251 and is larger in thickness in the radial direction than the small-diameter portion 251. The stator core 41 is positioned in the small-diameter portion 251. The circuit board 24 is positioned in the large-diameter portion 252. As illustrated in FIG. 2, the second O-ring 82 is positioned radially inside the large-diameter portion 252. Therefore, radially outward deformation of the insulator 42 due to the pressure from the second O-ring 82 is reduced or eliminated by the large-diameter portion 252. This allows the second O-ring 82 to be brought into closer-contact with the bearing housing 22 and the insulator 42.

In the present embodiment, the first inner groove 61 and the first outer groove 71 are positioned axially above the stator core 41. The second inner groove 62 is positioned axially below the stator core 41. In other words, the first inner groove 61, the first outer groove 71, and the second inner groove 62 are disposed at positions axially away from the stator core 41. For that reason, the attaching strength of the stator core 41 is not decreased by the presence of the grooves 61, 71, and 62. Disposing the first O-ring 81 and the second O-ring 82 away from the stator core 41 further prevents water droplets from intruding into the stator core 41.

Having described an exemplary embodiment of the present disclosure, the present disclosure is not limited to the embodiment.

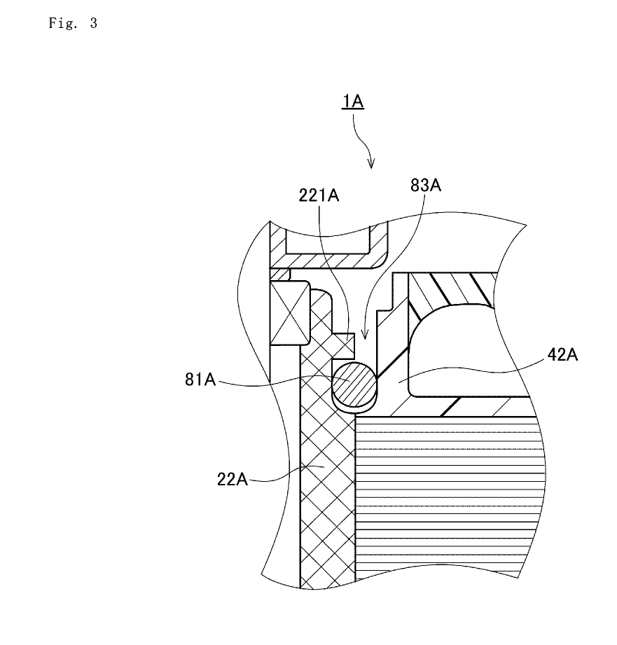

FIG. 3 is a partial longitudinal sectional view of a motor 1A according to a modification. In the example of FIG. 3, a bearing housing 22A includes an inner protrusion 221A. The inner protrusion 221A is positioned axially above a first O-ring 81A. The inner protrusion 221A protrude radially outward from the bearing housing 22A toward a gap 83A between the bearing housing 22A and an insulator 42A. Providing the inner protrusion 221A prevents the first O-ring 81A from coming out axially upward.

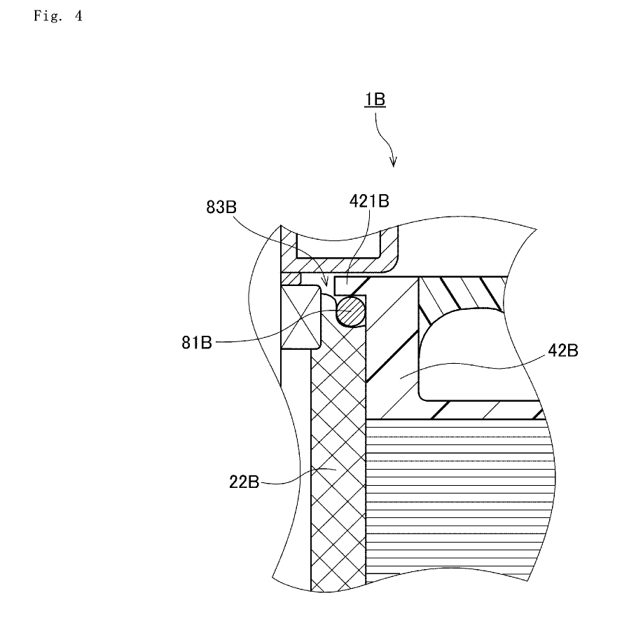

FIG. 4 is a partial longitudinal sectional view of a motor 1B according to another modification. In the example of FIG. 4, an insulator 42B includes an outer protrusion 421B. The outer protrusion 421B is positioned axially above a first O-ring 81B. The outer protrusion 421B protrudes radially inward from the insulator 42B toward a gap 83B between a bearing housing 22B and the insulator 42B. Providing the outer protrusion 421B prevents the first O-ring 81B from coming out axial upward.

In the above embodiment, the first O-ring 81 is interposed in the gap 83 in the radial direction between the bearing housing 22 and the insulator 42. However, in the example of FIG. 4, the gap 83B in the axial direction is present between the bearing housing 22B and the insulator 42B. The first O-ring 81B is interposed in the axial gap 83B. The first O-ring or the second O-ring may be interposed in the gap in the axial direction between the bearing housing and the insulator in this manner.

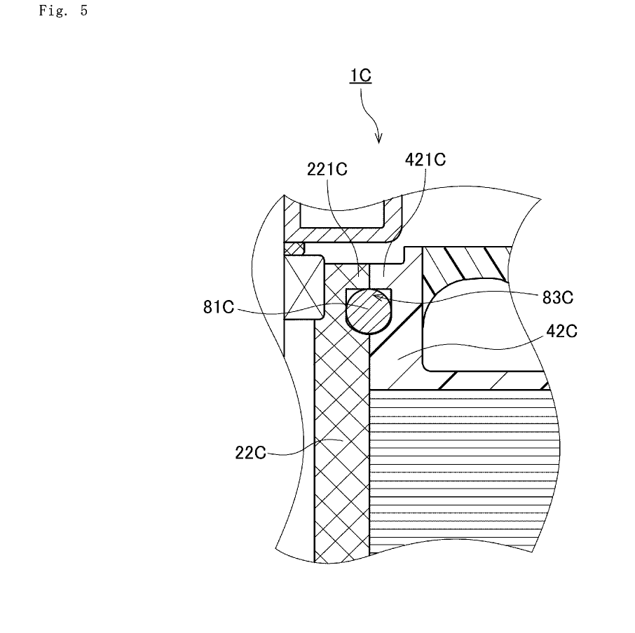

FIG. 5 is a partial longitudinal sectional view of a motor 1C according to still another modification. In the example of FIG. 5, a bearing housing 22C includes an inner protrusion 221C, and an insulator 42C includes an outer protrusion 421C. The inner protrusion 221C and the outer protrusion 421C are positioned axially above a first O-ring 81C. The inner protrusion 221C protrudes radially outward from the bearing housing 22C toward a gap 83C between the bearing housing 22C and the insulator 42C. The outer protrusion 421C protrudes radially inward from the insulator 42C to the gap 83C between the bearing housing 22C and the insulator 42C. The end of the inner protrusion 221C and the end of the outer protrusion 421C are opposed in the radial direction. Providing the inner protrusion 221C and the outer protrusion 421C prevents the first O-ring 81C from coming out axially upward.

In the above embodiment, the motor 1 includes the first O-ring 81 and the second O-ring 82. However, either one of the first O-ring 81 or the second O-ring 82 may be omitted. For example, the second O-ring 82 may be omitted, and intrusion of water droplets from below the stator unit 2 may be prevented by an adhesive or the like.

In the above embodiment, the O-ring 81 is used as an elastic member. However, the elastic member interposed between the bearing housing 22 and the insulator 42 may be another elastic member other than parts circulating in the market as so-called O-rings.

The present disclosure can be used in, for example, a stator unit and a motor.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A stator unit for use in a motor, the stator unit comprising:
a cylindrical bearing housing disposed along a central axis extending in a vertical direction;
a stator core fixed to an outer circumferential surface of the bearing housing and comprising a plurality of teeth protruding radially outward;
a resin insulator attached to the stator core;
a conductive wire wound around the teeth with the insulator therebetween;
a circuit board electrically coupled to the conductive wire;
a molded resin portion covering the stator core, the insulator, the conductive wire, and the circuit board;
at least one of the bearing housing and the insulator having a ring-shaped groove; and
an elastic member fitted in the groove and interposed between the bearing housing and the insulator.

2. The stator unit according to claim 1, wherein the bearing housing is made of metal.

3. The stator unit according to claim 1, wherein the bearing housing is made of resin.

4. The stator unit according to claim 1,
wherein the groove is provided on at least one of the outer circumferential surface of the bearing housing and an inner circumferential surface of the insulator, and
wherein the elastic member is sandwiched in a radial direction between the bearing housing and the insulator.

5. The stator unit according to claim 1,
wherein the groove comprises:
a first groove positioned axially above the stator core; and
a second groove positioned axially below the stator core, and
wherein the elastic member comprises:
a first elastic member fitted in the first groove; and
a second elastic member fitted in the second groove.

6. The stator unit according to claim 1, wherein the elastic member comprises a ring-shaped resin member.

7. The stator unit according to claim 1, wherein the groove communicates to outside through a gap between the bearing housing and the insulator.

8. The stator unit according to claim 7, wherein the bearing housing or the insulator comprises a protrusion protruding toward the gap.

9. The stator unit according to claim 1, wherein both of the bearing housing and the insulator comprise the groove.

10. The stator unit according to claim 1, wherein the circuit board and the elastic member differ in axial position.

11. The stator unit according to claim 1,
wherein the molded resin portion comprises:
a small-diameter portion; and
a large-diameter portion larger in radial thickness than the small-diameter portion, and
wherein the elastic member is positioned radially inside the large-diameter portion.

12. A motor comprising:
the stator unit according to claim 1; and
a rotor unit supported so as to be rotatable about the central axis and having a pole face radially facing an end face of the teeth.
